(19) United States
(12) Patent Application Publication
(10) Pub. No.: US 2014/0266639 A1
(43) Pub. Date: Sep. 18, 2014

(54) AUTOMATED MOBILE DEVICE CONFIGURATION FOR REMOTE CONTROL OF ELECTRONIC DEVICES

(71) Applicant: Matthew Scott Zises, San Jose, CA (US)

(72) Inventor: Matthew Scott Zises, San Jose, CA (US)

(73) Assignee: EBAY INC., SAN JOSE, CA (US)

(21) Appl. No.: 14/150,660

(22) Filed: Jan. 8, 2014

Related U.S. Application Data
(60) Provisional application No. 61/792,869, filed on Mar. 15, 2013.

(51) Int. Cl. G08C 17/02

(52) U.S. Cl. CPC G08C 17/02
USPC 340/12.28

(57) ABSTRACT

Configuration of a mobile electronic device with remote control functionality for a target electronic device for which an original remote control is unavailable is achieved by automated identification of control data for the target device based on non-textual device identification data captured by the mobile electronic device. The device identification data can include a picture of the target device or part thereof captured by the mobile electronic device. The picture may be automatically processed to identify the target device based on device shape, or based on device-specific symbols carried on an exterior of the target device. The device identification data can include signal data captured at device, including a wireless tag code, or location-specific data indicative of device location in an establishment.

### CLAIM OF PRIORITY

This application claims the benefit of priority to U.S. Provisional Patent Application Ser. No. 61/792,869, filed on Mar. 15, 2013, which is incorporated by reference herein in its entirety.

### TECHNICAL FIELD

This disclosure relates generally to data processing techniques. More specifically, the disclosure relates to configuration of mobile electronic devices with remote control functionality for consumer electronic devices, and in particular discloses methods, systems, and devices for auto-configuration of mobile electronic devices with device-specific remote control functionality.

### BACKGROUND

Remote controllers for consumer electronic devices, such as televisions, sound systems, home entertainment systems, cable set-top boxes, DVRs, and the like, are prone to misplacement. Many devices have at least some functions which can only be activated by use of remote control, with the result that a lost remote controller effectively reduces the functionality of the associated device. The absence of a remote controller moreover inconveniently necessitates manual control.

Universal remote control devices are available, and can be programmed to remotely control a wide variety of devices. Such dedicated universal remote controls, however, are equally likely to be misplaced, but with amplified user frustration because more devices are affected by its absence.

Multifunctional mobile electronic devices that have a wide range of applications (e.g., mobile phones) are misplaced less frequently. Techniques to customize or configure mobile phones to serve as remote controllers for electronic products can be tedious, often require a skilled user, and/or are often dependent on having the existing remote for the target device at hand. This is particularly problematic when the mobile phone is to be reconfigured for replace a missing remote control device.

### BRIEF DESCRIPTION OF THE DRAWINGS

Various features of the disclosure are illustrated by way of example, and not by way of limitation, in the figures of the accompanying drawings in which:

FIG. 1 is a schematic view illustrating an example embodiment of a mobile electronic device configured for automated configuration with remote control functionality for a target electronic device, based on device identification data in the example form of a digital image of a target device.

FIGS. 2A and 2B are respective schematic diagrams of example mobile device auto-configuration systems according to respective example embodiments.

FIG. 3A is a schematic block diagram of a server-side system for automated configuration of a mobile electronic device with remote control functionality, according to an example embodiment.

FIG. 3B is a schematic block diagram of a client-side system in the example form of a mobile electronic device configured for automated configuration with remote control functionality for a target device, in accordance with an example embodiment.

FIG. 4 is a schematic network diagram depicting a network system, according to one embodiment, having a client-server architecture configured for exchanging data over a network.

FIG. 5 is a schematic block diagram of a mobile electronic device in the example form of a mobile phone configured for automated configuration with custom remote control functionality for a target device, according to another example embodiment.

FIG. 6 is a flow diagram of an example method for automated configuration of a mobile electronic device to provide remote control functionality for consumer electronic products, in accordance with an example embodiment.

FIG. 7 shows a diagrammatic representation of machine in the example form of a computer system within which a set of instructions may be executed to cause the machine to perform any one or more of the methodologies discussed herein.

### DETAILED DESCRIPTION

One aspect of this disclosure describes automated retrieval and provision of auto-configuration data for a mobile electronic device to function as a remote controller for a target electronic device whose original remote control device is unavailable, based on device identification data captured as non-textual input by the mobile electronic device at the target device. The device identification data may comprise image data captured by an onboard camera of the mobile electronic device. Instead, or in addition, the device identification data may comprise signal data captured at the target device. “At the device” means at least within view of the target device.

The method may include processing the device identification data to identify the target device or target device type, and, in an automated operation, retrieving control command data for the target device, to enable automated reconfiguration of the mobile electronic device by use of the retrieved control command data. Note that the device identification data comprises non-textual input captured at the target device, and therefore does not include manual or textual user input of a device make and/or model. Note further that automated identification of control data necessary for configuration of the mobile electronic device with remote control functionality for the target device is based not on information pertaining to an original remote control device whose functionality is to be replaced, but is based on information pertaining to target device itself. This permits auto-configuration of the mobile electronic device with remote control functionality for the target device in the absence of an original remote control device for the target device.

In some embodiments, the device identification data may comprise image data representing an image captured by an onboard camera of the mobile electronic device. Automated device type recognition in such cases be based on image processing of the image data to recognize the target device type, for example, based on its shape represented in the captured image, based on symbols and/or characters carried on an exterior of the target device and represented in the captured image, or based on a visual product code for the target device represented in the captured image.

Instead, or in addition, the device identification data may comprise signal data captured in the device environment. In one embodiment, the device identification data comprises an identification code carried by wireless signals produced by a wireless tag incorporated in the target device. Such a wireless tag may comprise, for example, a Radiofrequency Identification (RFID) chip or a Near Field Communication (WC) device. In one embodiment, the device identification data may include location-specific signal data, for example forming part of an indoor positioning system (IPS), in which case recognition of the target device type may comprise identifying a location of the mobile electronic device within a particular establishment, and mapping the identified location to layout information for the establishment, to identify a particular device type associated in the layout information with the identified location.

In some embodiments, automated device type recognition may be performed off-site, at a remote processor. In such cases, the mobile electronic device may be configured to capture the device identification data, to transmit an auto-configuration data query to the remote processor over a data communications network, and to receive auto-configuration data (e.g., control command codes) specific to the identified target device type. The remote control application hosted on the mobile electronic device may automatically populate respective control code fields with the received auto-configuration data, to enable use of the mobile electronic device as remote controller for the target device.

FIG. 1 is a schematic view of an example mobile device in the form of a mobile phone 102 that is configured for auto-configuration based on non-textual device identification data to serve as custom remote control for consumer electronic devices. In the example embodiment of FIG. 1, auto-configuration of the mobile phone 102 comprises image-based auto-configuration. The mobile phone 102 has a native image capturing device in the form of a digital camera 128, a display screen 138 of the mobile phone 102 serving as a viewfinder for the camera 128. As will be described further herein, the mobile phone 102 has a memory storing software applications that enables automated custom reconfiguration of the mobile phone 102 for customizable remote control functionality.

FIG. 2A is a schematic diagram illustrating example embodiment of a system 200 for auto-configuration of the example mobile phone 102 in a domestic setting. This example embodiment will further be described with reference also to FIG. 6, which shows a flowchart of an example embodiment of a method 600 to auto-configure a mobile electronic device for providing it with remote control functions.

When a user 203 (see FIG. 2) wants to use the mobile phone 102 as a remote control for a particular electronic device, the user can, at operation 603 of FIG. 6, capture device identification data at a particular electronic device for which the mobile phone 102 is to be used as a remote controller, without having access to an original, dedicated remote control device for the target device, and without requiring manual textual input to identify the target device or target device type in order to retrieve device-specific control command data (e.g., control codes) for the target device. In this example, the mobile phone 102 is to be used as a remote control for a television 105, which is thus the target device.

The capturing of the device identification data, at operation 603 (FIG. 6) can comprise the capturing of image data, at operation 601, for example by taking a digital image with the onboard camera 128 of the phone 102, with the digital image including information on which device identification and be based. In this example embodiment, the captured image is in the example form of a digital picture 605 (see FIGS. 1 and 6) of the target device 105 as a whole. In other embodiments, the method may include capturing instead, or in addition, images of one or more related artifacts or device features that enable product identification in the absence of an original remote control that was shipped with the target device.

FIG. 6 show an example selection of alternative/additional device identification data sources from which device-specific information can be gathered by the user 203 with the mobile phone 102. Thus, for example, a photo may be taken of brand and/or product indicia 133, as indicated by characters and/or symbols that are physically present on the target device 105 (see also FIG. 1). A picture may likewise be taken of product code information 614 at a rear or underside of the target device 105, and/or of product packaging 616 in which the target device 105 was shipped.

Automated optical identification of the target device 105 may instead, or in addition, comprise scanning an optical code by use of the mobile phone 102. This can comprise, for example, taking a digital picture of a barcode 258 (see also FIG. 2) of the target device 105, or scanning the barcode 258, e.g. by use of a peripheral infrared scanner connected to the mobile phone 102, A Universal Product Code (UPC) 254 associated with the target device 105 may likewise be photographed or scanned.

The capturing of the device identification data, at operation 603, may in some embodiments include, at operation 602, capturing wireless signal data from the device environment, with the wireless signal data being unique to the device environment in order to enable positive device identification. The user 203 can, for example, capture wireless signals emitted by a wireless tag incorporated in a particular electronic device. Such wireless tags may include, for example, radiofrequency identification (RFID) chips, near field communication (NFC) devices, Bluetooth™, or WiFi devices.

In the example embodiment of FIG. 2A, a DVD device, for example, has incorporated therein an NFC device 278 emitting a wireless signal carrying a unique tag code. The capturing of the device identification data may in such a case comprise bringing the mobile phone 102 sufficiently close to the DVD 275 to receive the wireless tag signal emitted by the NFC device 278, and to store tag code data carried by the wireless signal on the mobile device 102. FIG. 2B shows a further example embodiment, in which the capturing of device identification data by capturing wireless signals, at operation 602, comprises capturing location-specific wireless communication signals in the device environment.

In the example embodiment of FIG. 2B, an establishment in the example form of a retail store 290 has a showroom on which a variety of different types of electronic devices 205 are displayed. The store 290 includes an indoor positioning system comprising multiple location beacons 298 distributed throughout the store premises and, in particular, the showroom. The beacons 298 have a limited range, with each beacon 298 transmitting a unique location-identifying packet sequence according to a Bluetooth® low energy (BLE) protocol. A specific indoor location of the mobile phone 102 can thus be established by particular location-identifying packet sequences received by the mObile phone 102 from one or more particular beacons 298. A store computer system 291 can include a store map 292 in which information is stored regarding the locations on the showroom of the respective types of electronic devices 205. The particular electronic device 205 at which the mobile phone 102 is located can thus be established based on the location-specific wireless signals, with reference to the store map 292.

Returning now to FIG. 2A, it can be seen that, if the user 203 wishes to employ the mobile phone 102 as a universal remote control for a number of target devices or appliances, the operation of capturing the identifying image data (at operation 601) may be repeated, at operation 619 (FIG. 6), for each of the respective target devices that are to be controlled by the mobile phone 102. In the example embodiment of FIG. 2, the user 203 takes a photograph 605 of the television 105, scans the barcode 258 of an electronic sound system 257, takes a digital photo of the UPC 254 of a DVR 253, and reads the NFC code of the DVD player 275. In the example embodiment of FIG. 2, there are thus four target devices for which the mobile phone 102 is to serve as a universal remote control. The multiple target devices are commonly indicated by reference numeral 105 in this description, unless the context indicates otherwise.

Device identifying data thus captured is received and stored by the mobile phone 102, at operation 620, and may be processed by the mobile phone 102 under direction of dedicated software, to generate a request for auto-configuration data, at operation 622, and to transmit the remote control auto-configuration data request, at operation 624, to an off-site server for product recognition and/or control code data retrieval.

In this example embodiment, the auto-configuration functionality is supported by an online application support system 277 (FIG. 2) and one or more manufacturer or service provider systems 267 (FIG. 2). The auto-configuration data request can in this example be transmitted, e.g. via the Internet 244, to the application support system 277 for device recognition. The application support system 277 may thus process the received device identification data to recognize a particular device attribute indicated by the captured device identification data, and to identify a device type of the target device 105 based on the recognize device attribute. To facilitate such automated device type recognition, the application support system 277 may access one or more product databases 279 (FIG. 2), in which device identification data (including, for example, image data) for a wide variety of electronic devices is stored.

Note that identification of the target device 105, means identifying a particular device type of which the target device 105 is an instance. A “device type” means information about device make and/or model which is sufficiently specific to permit accurate identification of remote control configuration data corresponding to the relevant target device 105. Granularity of device type identification may vary from one electronic device to another, corresponding to granularity of differentiation between remote control command codes by original equipment manufacturers of the respective devices. In instances, for example, where all televisions of a particular brand share common remote control command codes, automated recognition of device type, at operation 630, may comprise recognizing that the target device 105 is a television, and recognizing the device brand/make. In other instances where, for example, remote control command codes are model-specific, so that different product models have different remote control codes, device type identification may comprise identifying the specific make and the specific model of the target device 105. Unless the context clearly indicates the contrary, “device identification” and “device type-identification” are used synonymously and interchangeably herein to mean identification of the relevant device make and/or model that is sufficiently specific to enable accurate identification of correct remote control configuration data for the relevant device.

Processing of the device identification data, at operation 630, may vary depending on the type of device identification data captured at operation 603, in order to identify different respective attributes of the target device 105. If the device identification data comprises image data, an image processing operation may be performed, at operation 631. The image processing may comprise automated recognition, at operation 634, of a visual code (such as the barcode 258 or UPC code 254). Instead, or in addition, the image processing may comprise an optical character recognition (OCR) process, at operation 636, to recognize identifying characters or symbols carried on the exterior device, for example to recognize the brand and/or product indicia 133 represented in the captured image, or to recognize product information attached to a rear or an underside of the relevant electronic device. Instead, or in addition, the image processing may comprise image analysis, at operation 635, to recognize a shape of the target device 105 or of a particular feature of the target device 105. In instances where the device identification data comprises wireless data signals captured by the mobile phone 102, automated device identification may comprise, at operation 632, processing the captured wireless signal data to recognize a particular wireless tag code indicated by, for example, a captured REID or NEC signal transmitted by a wireless tag such as the NFC tag 278 of an associated electronic device.

The identified attribute of the target device 105 may then, at operation 637 (FIG. 6), be mapped to the product database 279, to identify the device type corresponding to the identified attribute. In cases where the identified attribute comprises information specific to a particular location or business entity, for example comprising a store-specific barcode 258, the identified attribute (e.g., a scanned barcode 258) may be mapped to product database for the relevant store or chain of stores, to identify the target device 105 based on store-specific identification attribute.

In embodiments where the device identification data comprises location-specific signals 690, such as in the example embodiment of FIG. 2B, the processing of the device identification data to recognize the target device 105, at operation 630, can comprise processing the location-specific signal 690, at operation 633, to identify the specific location of the mobile phone 102 in the store 290 (FIG. 2B). The relevant store map 292 can then be interrogated, at operation 638, based on the identified location, to establish the particular device type associated in the store layout with the identified location. The location-specific device type is then automatically assumed to be a device type for the target device 105.

Note that, in some embodiments, automated product recognition may instead partially or wholly be performed client-side, e.g. on the mobile phone 102 (at 623 in FIG. 6). In such a case, the auto-configuration data request may include results of the automated product recognition.

After the target device 105 has been identified positively, at operation 630, uniquely associated auto-configuration data for the target device 105 is retrieved, at 639, e.g. from a control code database 269 of a manufacture or service provider 267 associated with the recognized target device 105. While the application support system 257 may in this example request the relevant control code information from the manufacturer/service provider 267, the control code information may in other embodiments be hosted by the application support system 277 instead. Thereafter, the retrieved auto-configuration data is transmitted to the mobile phone 102, at operation 642, responsive to the auto-configuration query.

After the auto-configuration data is received by the mobile phone 102, at 646, an auto-configuration application(s) hosted on mobile phone 102 may automatically use the auto-configuration data, at operation 650, to configure the mobile phone 102 with control command codes for remote control of the respective target devices 105. A person of ordinary skill in the art will appreciate that the control codes specify the particular command codes responsive to which the respective target devices 105 are programmed to execute respective functions. Auto-configuration of the mobile phone 102 thus configures the mobile phone 102 to transmit to a user-selected target device 105 correct control codes for respective user-selected device functions. This may comprise populating function-specific data fields thr a remote control application on the mobile phone 102 with respective control codes received as part of the auto-configuration data. In some example embodiments, the method 600 may include custom or manual configuration of the mobile phone 102 by the user 203, at operation 654, using device type-specific control code information retrieved in response to the auto-configuration query.

To enable use of the mobile phone 102 as a remote controller, the mobile phone 102 may be configured (e.g., by a remote control application executing on the mobile phone 102) to display a graphical user interface (GUI) on which elements are displayed to permit user-selection of a particular target device 105 that is to be controlled, and to enable the user to command execution of particular functions by the respective devices. This may comprise, for example, pressing of a corresponding soft button on the GUI, responsive to which the mobile phone 102 transmits a corresponding wireless remote control command signal to the selected device 105, at 658. As schematically shown by broken lines in FIG. 2A, transmission of the command signals may comprise transmission of a carrier wave signal directly from the mobile phone 102 to the target device 105, for example by infrared signal (e.g., via a native infrared transmitter on the mobile phone 102, or via a peripheral infrared transmitter plugged into a port or jack of the mobile phone 102). In other instances, however, command signals may be transmitted via data packets over a computer network. In the example shown in FIG. 2, such network communication is achieved via a home computer network 252 that is in Wi-Fi communication with the mobile phone 102 and is communicatively coupled to one or more of the target electronic devices (in this example being connected to the sound system 257). Transmission of the digital signals may, in other embodiments, be achieved in a number of different ways, for example by Wi-Fi enabled target devices.

The method 600 may in some embodiments include, at operation 651 (FIG. 6), setting up the mobile phone 102 to selectively execute multi command control functions, sending a plurality of control signals responsive to a single user command. The user may, for example, customize the remote control application on the mobile phone 102 to achieve coordinated, multi-device control. In one example, the user can associate with a single command or soft button control signals to (a) switch the TV 105 to a particular input channel associated with the DVD 275, (b) switch on the DVD 275, (c) start playback of a disc in the DVD 275, (d) switch the sound system 257 to an audio input channel associated with the DVD 275, (e) switch off the DVR 253, and (f) change display settings of the TV 105 that particular setup, for example to a widescreen display mode. Note that the set of instructions that are to be performed automatically in executing a particular multi command control function can comprise multiple control commands for a particular device, control commands for a plurality of devices, or any combination thereof. The mobile phone 102 may be configured to allow the user to specify a particular sequence in which the multiple commands are to be performed. In some embodiments, the mobile phone 102 may allow predetermined, user-specified timing of the multiple commands, for example by allowing specification of predefined intervals or pauses between successive commands.

It is a benefit of the disclosed embodiments that little expertise is required from the user 203 to achieve configuration of his/her mobile phone 105 for use as a remote control. All that is required of the user is to capture device identification data at the device, for example by taking a photograph of the target device 105, and to authorize transmission of an auto generated configuration data request. It is a further benefit that the user does not need to know the particular control codes needed for remote control of the target device, and that the user does not have to populate the control codes in corresponding fields in a registry or memory of the mobile phone 102. These functions can be performed automatically by the mobile phone 102 executing auto-configuration software. Moreover, the user 203 does not need to have access to the original remote control device whose functionality is to be performed by the mobile phone 102, so that auto-configuration of the mobile phone 102 can readily be performed in the absence of target device's original remote control.

### Example Systems and Devices

Example embodiments of systems and/or devices for implementing the example methods described with reference to FIGS. 1-2, and 6 will now be described. FIG. 4 is a network diagram depicting a network system 400, according to one embodiment, having a client-server architecture configured for exchanging data over a network. For example, the network system 400 may be a publication/publisher system where clients may communicate and exchange data within the network system 400. The described architecture may thus, in the above-described example method 600, be used by the manufacturers/service providers 267, by an application support system 277, and/or by store computer systems 291. Although illustrated herein as a client-server architecture as an example, other embodiments may include other network architectures, such as a peer-to-peer or distributed network environment.

A data exchange platform, in an example form of a network-based publisher 402, may provide server-side functionality, via a network 404 (e.g., the Internet) to one or more clients. The one or more clients may include users that utilize the network system 400 and more specifically, the network-based publisher 402, to exchange data over the network 404. These transactions may include transmitting, receiving (i.e., communicating) and processing data to, from, and regarding content and users of the network system 400. The data may include, but are not limited to, content and user data such as feedback data; user reputation values; user profiles; user attributes; product and service reviews; product, service, manufacture, and vendor recommendations and identifiers; product and service listings associated with buyers and sellers; auction bids; transaction data; remote control auto-configuration queries; remote control auto-configuration data; device identification data; and remote control code information, among other things.

In various embodiments, the data exchanges within the network system 400 may be dependent upon user-selected functions available through one or more client or user interfaces (Us). The Lis may be associated with a client machine, such as a client machine 406 using a web client 410. The web client 410 may be in communication with the network-based publisher 402 via a web server 420. The UIs may also be associated with a client machine 408 using a programmatic client 412, such as a client application, or a third party server hosting a third party application.

A mobile device 432 corresponding, e.g., to the mobile phone 102 of the previously described example embodiment) may also be in communication with the network-based system 402 via a web server 420. The mobile device 432 may include a portable electronic device providing at least some of the functionalities of the client machines 406 and 408. The mobile device 432 may include third party remote control application(s) 416 (or a web client) configured to communicate with application server 422. Further details of an example mobile device 432 are described below with reference to FIG. 5.

Turning specifically to the network-based publisher 402, an application program interface (API) server 418 and a web server 420 are coupled to, and provide programmatic and web interfaces respectively to, one or more application servers 422. The application servers 422 host one or more publication application(s) 424. The application servers 422 in this example embodiment further host a remote control support application(s) 473 to perform the functionality described with reference to the example method 600 of FIG. 6. The application servers 422 are, in turn, shown to be coupled to one or more database server(s) 426 that facilitate access to one or more database(s) 428. These databases may include control code database(s) 269, product database(s) 279, and/or store map database(s) 292, as described above.

In one embodiment, the web server 420 and the API server 418 communicate and receive data pertaining to listings, transactions, and feedback, among other things, via various user input tools. For example, the web server 420 may send and receive data to and from a toolbar or webpage on a browser application (e.g., web client 410) operating on a client machine (e.g., client machine 406). The API server 418 may send and receive data to and from an application (e.g., programmatic client 412 or third party application 416) running on another client machine (e.g., client machine 408 or third party server 414).

FIG. 3A illustrates an example embodiment of a of a server-side system 370 for automated configuration of mobile electronic devices with remote control functionality for consumer electronic devices, for example to perform the server side functions described with reference to example method 600 of FIG. 6. In one embodiment, the system 370 may be provided by the example application server 422 executing the example remote control support application(s) 473. The system 370 includes a data access module 373 configured for accessing device identification data for a target device for which the mobile electronic device is to serve as a remote controller. The data access module 373 may, for example, comprise a network interface connected to the network 404 (FIG. 4) for receiving and/or reading device identification data, as described with reference to the example embodiment of FIG. 6, from a mobile electronic device.

The system 370 further comprises a device identification module 375 configured for identifying a device type for the target device based on the device identification data. The device identification module 375 may be configured to process received device identification data as described with reference to example operation 630 of the example embodiment of FIG. 6. In accordance with provides respective components of a server-side system for providing their respective functions described above with reference to the example method 600 of FIG. 6. The device identification module 375 may include an image processing module 314 configured to perform image processing on image data forming part of the received device identification data. The device identification module 375 can also include a signal processing module 316 for processing wireless signal data forming part of the device identification data, to identify the target device type based on, e.g., wireless tag information of the target device, or a location of the mobile electronic device from which the identification data is received. The image processing module 314 may thus be configured to recognize identifying characters/symbols, device shapes or device feature shapes, a visual product codes, visual device packaging identifiers (e.g., unique trade dress elements of device packaging), or other visual attributes of the target device represented in the received image data. The device identification module 375 may instead, or in addition, the configured to identify the target device based on location-specific wireless communication signals captured in the device environment by the mobile electronic device (as described, for example, with reference to operations 633 and 638 in the example method of FIG. 6).

The system 370 further comprises an auto-configuration module 377 configured to retrieve auto-configuration data for the identified target device (e.g., corresponding to example operation 639 of the example embodiment described with reference to FIG. 6). The auto-configuration module 377 may further be configured to transmit the auto-configuration data to the requesting mobile electronic device (e.g., corresponding to example operation 642 of FIG. 6).

FIG. 3B illustrates an example embodiment of a client-side system in the form of a mobile electronic device 300 configured for automated configuration with remote control functionality for a target device based on device identification data captured at the target device. The mobile electronic device 300 may be configured to perform the functions described as being performed by the example mobile phone 102 with reference to the example method 600 of FIG. 6. The respective components or modules of the example mobile electronic device 300 may in some embodiments be provided by a mobile device 432 executing remote control application(s) 212, as described with reference to FIG. 4.

The mobile electronic device 300 comprises a data access module 306 for accessing device identification data, the data access module 306 including a data capture module 303 configured to capture device identification data for a target device, for example as described with reference to example operation 603 in the example embodiment of FIG. 6. The data capture module 303 may thus comprise a camera or a wireless signal receiver to capture image data or wireless data signals in the device environment.

The mobile electronic device 300 further comprises a device identification module 321 for identifying the device type of the target device based on the captured device identification data. In this example embodiment, processing of the image data or signal data for identifying the target device is to be performed server-side, and the device identification module 321 thus includes a request module 352 to generate and transmit an auto-configuration request (e.g., as described with reference to operations 622 and 624 in the example embodiment of FIG. 6) that includes the captured device identification data. The request module 352 also forms part of a data retrieval module 309 to retrieve auto-configuration data for the target device based on the device identification data. Note that, in embodiments where processing of the device identification data is to be performed client-side, the mobile electronic device 300 may include an image processing module 314 and/or a signal processing module 316 as described with reference to FIG. 3A.

The device 300 may further include an auto-configuration module 328 to configure the device 300 with remote control functionality for the relevant target device, based on auto-configuration data retrieved by the data retrieval module 309, for example as described above with reference to FIG. 6. The mobile electronic device 300 may also include a remote control module 319 (for example provided at least in part by remote control application(s) 212 executing on the device 300), to transmit remote control signals to the target device, the remote control signals including control code information received as part of the auto-configuration data,

### Example Mobile Device

FIG. 5 is a block diagram illustrating a more particular example embodiment of a mobile electronic device 300 that may be employed to provide the functionalities described, e.g., with reference to a mobile phone 102 (see FIGS. 1-2 and 6). According to an example embodiment, the mobile device 300 may include a processor 510 and has an image capture device in the form of a camera 215 that can capture both digital photos and/or digital video content. The processor 510 may be any of a variety of different types of commercially available processors suitable for mobile devices (for example, an XScale architecture microprocessor, a Microprocessor without interlocked Pipeline Stages (MIPS) architecture processor, or another type of processor). A memory 520, such as a Random Access Memory (RAM), a Flash memory, or other type of memory, is typically accessible to the processor 510. The memory 520 may be adapted to store an operating system (OS) 540, as well as application programs 512 comprising instructions for execution by the processor 510. In this example embodiment, the applications 512 includes the remote control application(s) 212 to provide the functionalities discussed with reference to FIG. 6, and to configure the device 300 to provide respective modules discussed with reference to FIG. 3B.

A scanning layer 530 may be provided for scanning visual codes based on image information capture via the camera 215. The processor 510 may be coupled, either directly or via appropriate intermediary hardware, to a display 550 and to one or more input/output (I/O) devices 560, such as a keypad, a touch panel sensor, a microphone, and the like. Similarly, in some embodiments, the processor 510 may be coupled to a transceiver 570 that interfaces with an antenna 590. The transceiver 570 may be configured to both transmit and receive cellular network signals, wireless data signals, or other types of signals via the antenna 590, depending on the nature of the mobile device 300. In this manner, a connection with the communication network 244 or 404 may be established. The transceiver 570 may include an NFC receiver and/or an REID receiver to receive wireless tag signals.

In this example embodiment, the mobile device 300 further comprises a beacon signal receiver 580 to receive location-specific signals from one or more of the beacons 298 discussed with reference to the example embodiment of FIG. 2B, to cooperate with an indoor positioning system for determining a specific location of the device 500. In other embodiments, the device 500 may be configured for compatibility with different positioning systems, including other indoor positioning protocols, or a including a global positioning system.

### Components, and Logic of Example Embodiments

Certain embodiments are described herein as including logic or a number of components, modules, or mechanisms. Modules may constitute either software modules, with code embodied on a non-transitory machine-readable medium (i.e., such as any conventional storage device, such as volatile or non-volatile memory, disk drives or solid state storage devices (SSDs), etc.), or hardware-implemented modules. A hardware-implemented module is a tangible unit capable of performing certain operations and may be configured or arranged in a certain manner. In example embodiments, one or more computer systems (e.g., a standalone, client, or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry or in temporarily configured circuitry (e.g., configured by software), may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time,

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., Application Program Interfaces (APIs).)

FIG. 7 shows a diagrammatic representation of a machine in the example form of a computer system 700 within which there may be executed a set of instructions 724 for causing the machine to perform any one or more of the methodologies discussed herein. For example, the system 100 (FIG. 1) or any one or more of its components (FIGS. 1 and 2) may be provided by the system 700.

In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a server computer, a client computer, a personal computer (PC), a tablet PC, a set-top box (STB), a Personal Digital Assistant (PDA), cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU) a graphics processing unit (GPU) or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an alpha-numeric input device 712 (e.g., a keyboard), a cursor control device 714 (e.g., a mouse), a disk drive unit 716, an audio/video signal input/output device 718 (e.g., a microphone/speaker) and a network interface device 720.

The disk drive unit 716 includes a machine-readable storage medium 722 on which is stored one or more sets of instructions 724 (e.g., software embodying any one or more of the methodologies or functions described herein. The instructions 724 may also reside, completely or at least partially, within the main memory 704 and/or within the processor 702 during execution thereof by the computer system 700, the main memory 704 and the processor 702 also constituting non-transitory machine-readable media.

The instructions 724 may further be transmitted or receive over a network 726 via the network interface device 720,

While the machine-readable storage medium 722 is shown in an example embodiment to be a single medium, the term “machine-readable medium” should be taken to include a single medium or multiple media (e.g., a centralized or distributed database and/or associated caches and servers) that store the one or more sets of instructions 724. The term “machine-readable medium” shall also be taken to include any medium that is capable of storing a set of instructions for execution by the machine and that cause the machine to perform any one or more of the methodologies of this disclosure. The term “machine-readable medium” shall accordingly be taken to include, but not be limited to, solid-state memory devices of all types, as well as optical and magnetic media.

Thus, systems and methods for automated configuration of a mobile electronic device for remote control use are disclosed. Although these methods and systems have been described with reference to specific example embodiments, it will be evident that various modifications and changes may be made to these embodiments without departing from the broader spirit and scope thereof. Accordingly, the specification and drawings are to be regarded in an illustrative rather than a restrictive sense.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules or objects that operate to perform one or more operations or functions. The modules and objects referred to herein may, in some example embodiments, comprise processor-implemented modules and/or objects.

What is claimed is:

1. A system comprising:
a data access module configured for accessing device identification data for a target device of which an original remote control device is unavailable, the device identification data being non-textual input captured by a mobile electronic device and comprising at least one of: image data representing the target device or a related artifact, and signal data captured at the target device;
a device identification module configured for identifying a device type for the target device based on the device identification data; and
an auto-configuration module configured to retrieve auto-configuration data based on the identified target device type, the auto-configuration data being specific to the identified target device type and being usable by the mobile electronic device to configure the mobile electronic device with remote control functionality for the target device.

2. The system of claim 1, wherein the image data comprises a picture of at least part of the target device captured by an onboard camera of the mobile electronic device, the system further comprising an image processing module configured to identify the target device type by automated image processing of the image data.

3. The system of claim 2, wherein the image processing module is configured to perform optical character recognition (OCR) on the image data, to recognize in the picture one or more symbols carried on an exterior of the device and indicating device information.

4. The system of claim 2, wherein the image processing module is configured to identify the target device type based on automated recognition of a shape of the target device.

5. The system of claim 2, wherein the image processing module is configured to recognize a visual product code carried by the target device and represented in the image data, the device identification module further being configured to identify the target device type by identifying a particular type of device associated in a visual product code database with the identified visual product code.

6. The system of claim 1, wherein the signal data indicates wireless data signals originating from the target device, the device identification module being configured to identify the target device type by recognizing a device identification code in the signal data.

7. The system of claim 6, wherein the wireless data signals originate from a near field communication device incorporated in the target device.

8. The system of claim 1, wherein the signal data indicates location-specific wireless communication signals captured in the device environment by the mobile electronic device, the device identification module being configured to:
determine a particular location of the mobile electronic device within an establishment having multiple electronic devices of different types located at distributed locations within the establishment;
access a location database in which is stored location information for the respective different types of electronic devices in the establishment; and
identify as the target device type a specific device type associated in a location database with the particular location of the mobile electronic device.

9. A mobile electronic device comprising:
a data capture module configured to capture device identification data for an electronic target device of which an original remote control device is unavailable, the device identification data being non-textual input comprising at least one of: image data representing the target device or a related artifact, and signal data captured at the target device;
a data retrieval module configured for retrieving auto-configuration data for the target device based on the device identification data; and
an auto-configuration module configured for, in an automated process using one or more processors, configuring the mobile electronic device with remote control functionality for the target device based on the auto-configuration data.

10. The mobile electronic device of claim 9, wherein the data retrieval module is configured to:
transmit a configuration data query to a remote processor via a data communications network; and
receive the auto-configuration data via the data communications network in response to the configuration data query.

11. The mobile electronic device of claim 9, wherein the auto-configuration module is configured to populate a plurality of control code fields on the mobile electronic device with respective function-specific control codes forming part of the retrieved auto-configuration data, the mobile electronic device further comprising a remote control module configured to transmit user-selected wireless command signals to the target device based on the respective function-specific control codes, to cause execution by the target device of corresponding device functions.

12. A method comprising:
accessing device identification data for a target device of which an original remote control device is unavailable, the device identification data being non-textual input captured by a mobile electronic device and comprising at least one of: image data representing the target device or a related artifact, and signal data captured at the target device;
in an automated operation performed by one or more computer processors, processing the device identification data to identify a device type for the target device; and
based on identification of the target device type, accessing auto-configuration data that is specific to the identified target device type and is usable by the mobile electronic device to configure the mobile electronic device with remote control functionality for the target device.

13. The method of claim 12, wherein the image data comprises a picture of at least part of the target device, the processing of the device identification data comprising automated image processing to identify the target device type.

14. The method of claim 13, wherein the automated image processing comprises an optical character recognition (OCR) operation to recognize device information displayed by one or more symbols carried on an exterior of the device.

15. The method of claim 13, wherein the automated image processing comprises identifying the target device type based on a physical shape of the target device.

16. The method of claim 13, wherein the automated image processing comprises a code recognition process to recognize a visual product code carried by the target device and represented in the image data, the identifying of the target device type comprising identifying a particular type of device associated in a visual product code database with the identified visual product code.

17. The method of claim 12, wherein the image data comprises a picture of original product packaging for the target device, the identifying of the device type comprising automated image processing to recognize one or more trade dress elements forming part of the original product packaging.

18. The method of claim 12, wherein the signal data indicates wireless data signals originating from the target device, the identifying of the target device type comprising recognizing a device identification code carried by the wireless data application signals.

19. The method of claim 18, wherein the wireless data signals originate from a near field communication device incorporated in the target device.

20. The method of claim 12, wherein the signal data comprises location-specific wireless communication signals, the identifying of the target device comprising:
based on processing the location-specific wireless communication signals, identifying a particular location of the mobile electronic device within an establishment having multiple electronic devices of different types located at various locations within the establishment; and
identifying as the target device type a specific device type associated in a location database with the particular location of the mobile electronic device.

21. The method of claim 12, further comprising transmitting the auto-configuration data to the mobile electronic device.

22. A method comprising:
at a mobile electronic device, capturing device identification data for an electronic target device for which an original remote control device is unavailable, the device identification data being non-textual input and comprising at least one of: image data representing the target device or a related artifact, and signal data captured at the target device;
at the mobile electronic device, accessing auto-configuration data for the target device, the auto-configuration data having been identified based on the captured device identification data; and
in an automated operation that uses the auto-configuration data and that is performed by one or more processors of the electronic device, configuring the mobile electronic device with remote control functionality for the target device.

23. The method of claim 22, wherein the accessing of the auto-configuration data comprises:
transmitting a configuration data query to a remote processor via a data communications network; and
in response to the configuration data query, receiving the auto-configuration data via the data communications network.

24. The method of claim 23, wherein
the auto-configuration data is specific to a device type to which the target device belongs and comprises control codes for wireless transmission to the target device to cause execution by the target device of corresponding device functions, and wherein
the configuring of the mobile electronic device is performed by an auto-configuration application hosted on the mobile electronic device, the configuring comprising populating control code fields in a remote control application with the corresponding control codes received in response to the configuration data query.

25. A non-transitory machine-readable storage medium comprising instructions that, when executed by one or more processors of a machine, cause the machine to perform operations comprising:
access device identification data for a target device of which an original remote control device is unavailable, the device identification data being non-textual input captured by a mobile electronic device and comprising at least one of:
image data representing the target device or a related artifact, and signal data captured at the target device;
identify a device type for the target device by automated processing of the device identification data; and
based on identification of the target device type, access auto-configuration data that is specific to the identified target device type and is usable by the mobile electronic device to configure the mobile electronic device with remote control functionality for the target device.
